(19) United States
(12) Patent Application Publication
(10) Pub. No.: US 2026/0074419 A1
(43) Pub. Date: Mar. 12, 2026

(54) ANTENNA STRUCTURE AND ELECTRONIC DEVICE

(71) Applicant: WNC Corporation, Hsinchu (TW)

(72) Inventors: Tzu-Kuan SUN, Hsinchu (TW); Ching-Wen CHEN, Hsinchu (TW)

(21) Appl. No.: 19/312,473

(22) Filed: Aug. 28, 2025

Related U.S. Application Data
(60) Provisional application No. 63/691,498, filed on Sep. 6, 2024.

(30) Foreign Application Priority Data
Mar. 21, 2025 (TW) 114110777

(51) Int. Cl. H01Q 1/48; H01Q 1/22; H01Q 9/04

(52) U.S. Cl. CPC H01Q 1/48; H01Q 1/22; H01Q 9/0421

(57) ABSTRACT

An antenna structure includes a signal unit and a first ground unit. The signal unit is configured for disposing a feeding port thereon. The first ground unit has a generally tubular or ring-shaped form. The first ground unit is disposed correspondingly to the signal unit and includes a first ground end. The first ground end is configured to be connected to a system ground. The signal unit and the first ground unit are made of the same or different conductive materials.

### RELATED APPLICATIONS

This application claims the benefit of priorities to U.S. Provisional Application Number 63/691,498, filed on Sep. 6, 2024, and Taiwan Application Number 114110777, filed on Mar. 21, 2025. The entire content of the above identified applications are incorporated herein by reference.

### BACKGROUND

### Technical Field

The present disclosure relates to an antenna structure and an electronic device, and more particularly, to an antenna structure and an electronic device with at least one ground unit.

### Description of Related Art

With the advancement of technology, the demand for functional characteristics and aesthetic appearance of electronic devices are increasing. As a result, the component configuration within electronic devices needs to be more compact, leading to limited space for antenna placement or antennas being too close to adjacent components, thereby causing interference between the antenna and nearby components, affecting their functional characteristics.

In view of the above, there is a need to develop an antenna structure and electronic device that help overcome limited configuration space and reduce interference between antennas and adjacent components.

### SUMMARY

The present disclosure provides an antenna structure and an electronic device, where the antenna structure includes a first ground unit and a signal unit. The first ground unit is disposed correspondingly with the signal unit and includes a first ground end for connecting to a system ground. The signal unit and the first ground unit are made of the same or different conductive materials, which helps the first ground unit act as a radiating element of the antenna structure. The first ground unit may or may not be an existing conductive component in the electronic device and can increase the bandwidth while meeting antenna efficiency requirements.

In one aspect, the present disclosure provides an antenna structure that includes a signal unit and a first ground unit. The signal unit is configured for disposing a feeding port thereon. The first ground unit has a generally tubular or ring-shaped form, disposed correspondingly to the signal unit, and includes a first ground end for connecting to a system ground. The signal unit and the first ground unit are made of the same or different conductive materials.

In yet another aspect, the present disclosure provides an electronic device that includes a system ground, a module, a signal unit, and a first ground unit. The module includes a second ground unit, which is a metal casing. The signal unit includes a feeding port. The first ground unit is disposed correspondingly to the signal unit, and the second ground unit is connected to the system ground through the first ground unit.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of an antenna structure according to a first embodiment of the present disclosure.

FIG. 2 is a schematic diagram an antenna structure according to a second embodiment of the present disclosure.

FIG. 3 is a schematic diagram of an electronic device according to a third embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

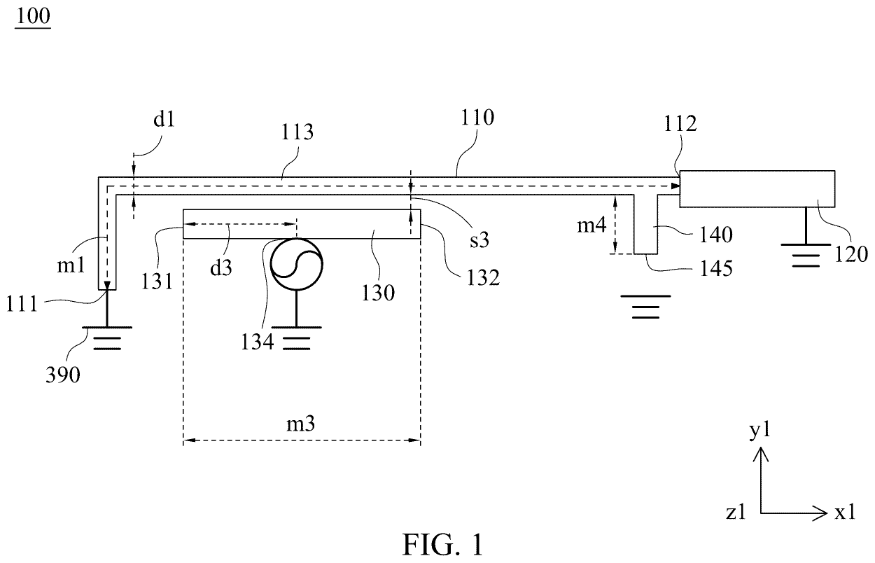

FIG. 1 illustrates a schematic diagram of an antenna structure 100 of the first embodiment of the present disclosure. Referring to FIG. 1, the antenna structure 100 includes a signal unit 130 and a first ground unit 110. The signal unit 130 is configured for disposing a feeding port 134. The first ground unit 110 has a generally tubular or ring-shaped form, for example, the first ground unit 110 forms a hollow tube shape with unsealed ends made of conductive or metal thin material, or the first ground unit 110 is a ring-shaped shell made of conductive or metal material, but the present disclosure is not limited thereto. The first ground unit 110 is disposed correspondingly to the signal unit 130 and includes a first ground end 111 configured to be connected to a system ground 390. When the antenna structure 100 is disposed in an electronic device, such as the electronic device 300 of the third embodiment, the system ground 390 is the ground of the electronic device 300. Furthermore, the signal unit 130 and the first ground unit 110 are made of the same or different conductive materials. This helps the first ground unit 110 serve as the radiating element of the antenna structure 100, where the first ground unit 110 may or may not be an existing conductive component in the electronic device 300, and the antenna structure 100 can increase bandwidth while meeting antenna efficiency requirements. For example, the antenna structure 100 can be used in MIMO (Multi-Input Multi-Output) and/or WLAN (Wireless Local Area Network) wireless communication systems, but the present disclosure is not limited thereto. Furthermore, the first ground unit 110 extends along the plane formed by the first direction x1 and the second direction y1 in the direction of length m1 in FIG. 1, and the first ground unit 110 can be a round metal sleeve or formed into a round shape with metal cloth (not limited thereto).

In detail, the antenna structure 100 may further include a second ground unit 120. The first ground unit 110 may further include a second ground end 112, which is configured to be connected to the second ground unit 120, and the second ground unit 120 is configured to be connected to the system ground 390 through the first ground unit 110. This allows the antenna structure 100 to make use of existing conductive components in the electronic device 300 (i.e., the second ground unit 120) and meet antenna size and operating frequency band requirements. Specifically, the second ground unit 120 can be a metal casing, such as the metal casing of the module 380 in the electronic device 300 of the third embodiment, where the module 380 can be a camera module or other modules, and the metal casing can be used for electromagnetic shielding, but the present disclosure is not limited thereto.

The first ground unit 110 can enclose a plurality of wires (not shown), for example, eight wires, but the present disclosure is not limited thereto. The plurality of wires may include signal lines, power lines, data lines, or ground lines, depending on electrical requirements. The first ground unit 110 is provided on the outer surface of the plurality of wires, for example, the first ground unit 110 may be a conductive fabric wrapped around the wires for electromagnetic shielding. From a radio frequency perspective, the first ground unit 110 can be regarded as a three-dimensional metallic element with a specific outer diameter.

The diameter d1 of the first ground unit 110 can be between 0.5 mm and 3 mm. This satisfies the electrical connection requirements of the wires enclosed by the first ground unit 110 while meeting the size requirements of the antenna structure 100. Specifically, the diameter d1 of the first ground unit 110 is 1 mm.

The length m1 of the first ground unit 110 can be between 30 mm and 60 mm. This helps design the first ground unit 110 to be ¼ wavelength of the operating frequency, forming a coupled-type antenna with the signal unit 130.

The length m3 of the signal unit 130 can be between 5 mm and 25 mm. This provides the required operating frequency.

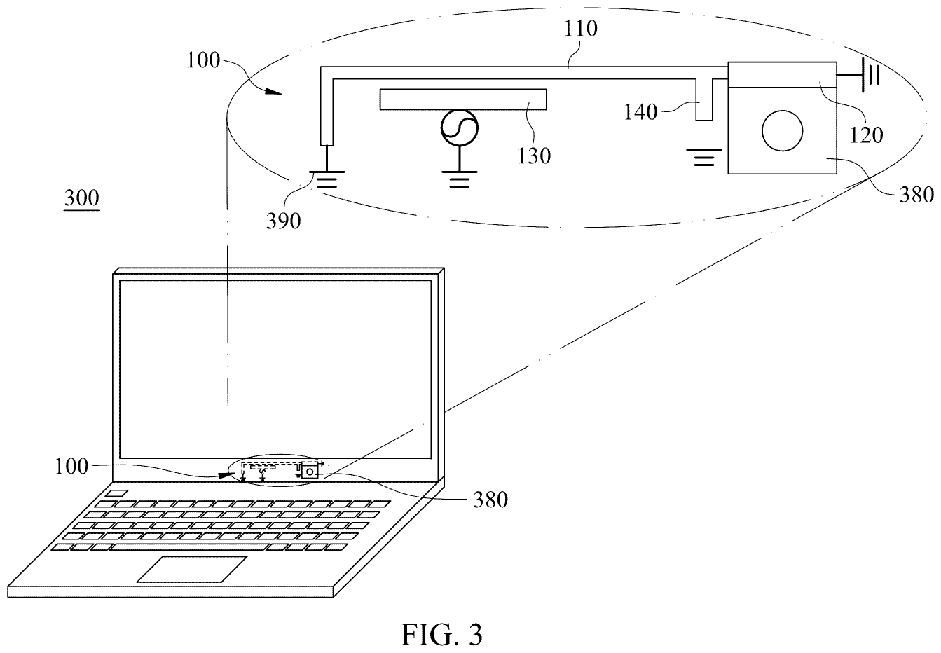

The first ground unit 110 can include a coupling part 113, which couples with the signal unit 130, and the signal unit 130 includes a first signal end 131 and a second signal end 132, where the first signal end 131 is closer to the first ground end 111 than the second signal end 132. This forms a coupled-type antenna between the first ground unit 110 and the signal unit 130, increasing bandwidth while meeting antenna efficiency requirements, especially when applied in a cleaner surrounding environment, such as the position of the hinge cap (as shown in FIG. 3) of a notebook computer, but the present disclosure is not limited thereto. Furthermore, the term “connect” described in the present disclosure refers to physical connection between two components, either direct or indirect connection, and the term “couple” described in the present disclosure refers to separation between two components without physical connection, and excitation of the electric field energy of one component by the electric field energy generated by the current of another component.

The distance s3 between the signal unit 130 and the coupling part 113 can be between 0.1 mm and 5 mm. This helps the antenna structure 100 have appropriate coupling energy and bandwidth.

There is a feeding port distance d3 between the feeding port 134 and the first signal end 131, where the ratio of the feeding port distance d3 to the length m3 of the signal unit 130 can be between 0.33 and 0.5. This helps achieve impedance matching and enhance bandwidth.

The antenna structure 100 may further include a stub unit 140, which connects to the first ground unit 110 and includes an open end 145, where the stub unit 140 is farther away from the first ground end 111 than the signal unit 130. This provides impedance matching effect without additionally increasing the area of the antenna structure 100.

One of the signal unit 130 and the stub unit 140 can be a conductor on a circuit board, a copper foil, or manufactured through laser direct structuring (LDS). This helps integrate the antenna structure 100 into the existing architecture of the electronic device 300 without increasing the design and manufacturing burden of the electronic device 300.

The length m4 of the stub unit 140 can be between 3 mm and 10 mm. This allows the open end 145 to couple with the system ground 390 (e.g., in copper foil form), making the stub unit 140 have equivalent capacitance effect on the system ground 390, thereby adjusting the impedance matching of the first ground unit 110.

Additionally, in the embodiments of the present disclosure, the shapes of the signal unit, first ground unit, second ground unit, and stub unit in the antenna structure are not limited to those illustrated in the drawings, and the shapes of each unit are not limited to extending or distributing in the plane formed by the first direction x1 and the second direction y1, any part of each unit can also extend or distribute along the third direction z1 or other directions.

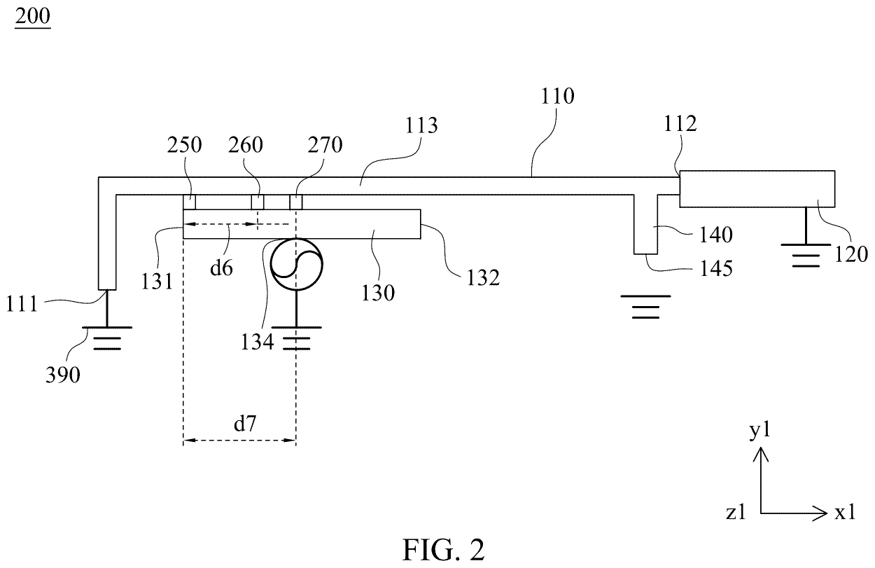

FIG. 2 illustrates a schematic diagram of an antenna structure 200 of the second embodiment of the present disclosure. Referring to FIG. 2, the antenna structure 200 of the second embodiment can add at least one of a resistor 250, an inductor 260 and a capacitor 270 to the antenna structure 100 of the first embodiment. Furthermore, the quantity of each of the resistor 250, inductor 260 and capacitor 270 can be one or multiple, and each of them can be in the form of surface mount devices (SMD) or metal patterns, or components exhibiting required resistance, inductance, or capacitance characteristics at operating frequencies, but the present disclosure is not limited thereto.

The antenna structure 200 may further include a resistor 250, which connects between the signal unit 130 and the coupling part 113. There is a resistor distance between the resistor 250 and the first signal end 131, and the ratio of the resistor distance to the length m3 of the signal unit 130 can be between 0 and 0.5, with a resistance value of the resistor 250 between 0 ohm and 75 ohm. This allows the antenna structure to change into a planar inverted-F antenna (PIFA) at the aforementioned position, enhancing the ability to resist environmental electromagnetic interference, especially when the antenna structure 200 is placed in a complex environment with multiple components, such as in or near the keyboard area of a notebook computer, but the present disclosure is not limited thereto. In the second embodiment, the resistor distance can be approximately 0, so it is not illustrated.

The antenna structure 200 may further include an inductor 260, which connects between the signal unit 130 and the coupling part 113. There is an inductor distance d6 between the inductor 260 and the first signal end 131, and the ratio of the inductor distance d6 to the length m3 of the signal unit 130 can be between 0.25 and 0.75. This helps improve antenna efficiency and bandwidth. When the antenna structure 200 includes the resistor 250, the antenna structure is a planar inverted-F antenna, and the inductor 260 helps increase the low-frequency path length of the planar inverted-F antenna, thereby providing low-frequency path length without increasing the size of the antenna structure 200 in the first direction x1.

The antenna structure 200 may further include a capacitor 270, which connects between the signal unit 130 and the coupling part 113. There is a capacitor distance d7 between the capacitor 270 the first signal end 131, and the ratio of the capacitor distance d7 to the length m3 of the signal unit 130 can be between 0.25 and 0.75. This helps adjust the impedance matching of the signal unit 130 coupled to the first ground unit 110 as a coupled arm, thereby enhancing coupling efficiency.

When the antenna structure 200 includes the inductor 260 and the capacitor 270, the inductor distance d6 can be smaller than the capacitor distance d7. Thus, by combining with the coupling effect between the coupling part 113 of the first ground unit 110 and the signal unit 130, helps improve antenna efficiency and bandwidth.

The inductance value of the inductor 260 can be between 15 nH and 330 nH, and the capacitance value of the capacitor 270 can be between 12 pF and 120 pF. This is beneficial for providing the required antenna efficiency and bandwidth.

FIG. 3 illustrates a schematic diagram of an electronic device 300 of the third embodiment of the present disclosure. Referring to FIG. 3, the electronic device 300 includes a system ground 390, a module 380, a signal unit 130, and a first ground unit 110, where the electronic device 300 specifically includes the antenna structure according to the present disclosure (e.g., the antenna structure 100 of the first embodiment) and can be a notebook computer, but the present disclosure is not limited thereto. The module 380 includes a second ground unit 120, which is a metal casing. The signal unit 130 includes a feeding port 134. The first ground unit 110 is disposed correspondingly to the signal unit 130, and the second ground unit 120 is connected to the system ground 390 through the first ground unit 110. This helps design the antenna structure 100 as a coupled type antenna, or further design it as a planar inverted-F antenna (e.g., the antenna structure 200), also meeting size and bandwidth requirements.

In detail, the first ground unit 110 may have a generally tubular or ring-shaped form and encloses multiple wires. As electronic devices increasingly demand enhanced functionality and aesthetic appearance, such as narrower screen bezels, the design of antennas in existing technology has become more challenging. For example, when an antenna in a conventional design is placed at the hinge cap of a notebook computer, the routing of the camera module's cable is configured to bypass the antenna pattern. This shields the radiating area and significantly impacts antenna performance. In contrast, the electronic device 300 according to the present disclosure effectively addresses this issue by converting the drawbacks of the cable routing of the module 380 routing (i.e., the wires enclosed by the first ground unit 110) into advantages. The first ground unit 110, which encloses the cable routing of the module 380, is designed as a low-frequency radiating element, such as for supporting MIMO and WLAN frequency bands, but the present disclosure is not limited thereto.

The module 380 can be a camera module, which may include a lens assembly, an image sensor or an electronic photosensitive element, and an image signal processing element (ISP). As shown in FIG. 3, the cable routing of the module 380 exits to the left and bypasses the top of the signal unit 130. The first ground unit 110 enclosing the module 380's cable routing and the signal unit 130 are designed as a coupled antenna pattern, which can resonate at a low-frequency mode (e.g., MIMO or WLAN frequency band). As such, the cable routing of the module 380 is no longer a source of interference but instead becomes a radiating-enhancing component, improving overall MIMO and WLAN performance. In other embodiments of the present disclosure (not shown), the camera module can be placed between two antennas/two signal units, and the cable routing of the camera module can exit to the left or right, bypassing one of the antennas/signal units (at the top). Furthermore, the module 380 can also be an image sensor or a module containing an image sensor. In some embodiments, the ground unit 110 may itself be the cable of the module 380. For example, when the module 380 is a camera module, the ground unit 110 may be a cable that is electrically connected to the camera module or forms part of the camera module assembly.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An antenna structure comprising:
a signal unit configured for disposing a feeding port; and
a first ground unit disposed correspondingly to the signal unit and comprising a first ground end, wherein the first ground unit has a generally tubular or ring-shaped form, and the first ground end is configured to be connected to a system ground;
wherein the signal unit and the first ground unit are made of the same or different conductive materials.

2. The antenna structure according to claim 1, further comprising:
a second ground unit;
wherein the first ground unit further comprises a second ground end connected to the second ground unit, the second ground unit is configured to be connected to the system ground through the first ground unit.

3. The antenna structure according to claim 1, wherein the first ground unit encloses a plurality of wires.

4. The antenna structure according to claim 1, wherein a diameter of the first ground unit is between 0.5 mm and 3 mm.

5. The antenna structure according to claim 1, wherein a length of the first ground unit is between 30 mm and 60 mm.

6. The antenna structure according to claim 1, further comprising:
a stub unit, connected to the first ground unit and comprising an open end, wherein the stub unit is farther from the first ground end than the signal unit.

7. The antenna structure according to claim 6, wherein one of the signal unit and the stub unit is a conductor on a circuit board, a copper foil, or formed through laser direct structuring.

8. The antenna structure according to claim 6, wherein a length of the stub unit is between 3 mm and 10 mm.

9. The antenna structure according to claim 1, wherein a length of the signal unit is between 5 mm and 25 mm.

10. The antenna structure according to claim 1, wherein the first ground unit comprises a coupling part configured to be coupled to the signal unit, the signal unit comprises a first signal end and a second signal end, and the first signal end is closer to the first ground end than the second signal end.

11. The antenna structure according to claim 10, wherein a distance between the signal unit and the coupling part is between 0.1 mm and 5 mm.

12. The antenna structure according to claim 10, wherein there is a feeding port distance between the feeding port and the first signal end, and a ratio of the feeding port distance to a length of the signal unit is between 0.33 and 0.5.

13. The antenna structure according to claim 10, further comprising:
a resistor connected between the signal unit and the coupling part, wherein there is a resistor distance between the resistor and the first signal end, a ratio of the resistor distance to a length of the signal unit is between 0 and 0.5, and a resistance value of the resistor is between 0 ohm and 75 ohm.

14. The antenna structure according to claim 10, further comprising:
an inductor connected between the signal unit and the coupling part, wherein there is an inductor distance between the inductor and the first signal end, and a ratio of the inductor distance to a length of the signal unit is between 0.25 and 0.75.

15. The antenna structure according to claim 10, further comprising:
a capacitor connected between the signal unit and the coupling part, wherein there is a capacitor distance between the capacitor and the first signal end, and a ratio of the capacitor distance to a length of the signal unit is between 0.25 and 0.75.

16. The antenna structure according to claim 15, further comprising:
an inductor connected between the signal unit and the coupling part, wherein there is an inductor distance between the inductor and the first signal end, and the inductor distance is smaller than the capacitor distance.

17. The antenna structure according to claim 16, wherein an inductance value of the inductor is between 15 nH and 330 nH, and a capacitance value of the capacitor is between 12 pF and 120 pF.

18. An electronic device, comprising:
a system ground;
a module comprising a second ground unit, which is a metal casing;
a signal unit comprising a feeding port; and
a first ground unit disposed correspondingly to the signal unit, wherein the second ground unit is connected to the system ground through the first ground unit.

19. The electronic device according to claim 18, wherein the first ground unit has a generally tubular or ring-shaped form and encloses a plurality of wires.

20. The electronic device according to claim 18, wherein the module is a camera module.
